(19) United States
(12) Patent Application Publication
(10) Pub. No.: US 2003/0061492 A1
(43) Pub. Date: Mar. 27, 2003

(54) Method and arrangement for a rights ticket system for increasing security of access control to computer resources

(76) Inventors: Roland Rutz, Berlin (DE); Reinhardt Coerdt, Zepernick (DE); Peter Werner, Berlin (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/169,680

(22) PCT Filed: Aug. 31, 2001
(86) PCT No.: PCT/EP01/10069

(30) Foreign Application Priority Data
Nov. 7, 2000 (DE) 100 56 135.7

(51) Int. Cl. H04K 1/00

(52) U.S. Cl. 713/182

(57) ABSTRACT

The invention relates to a method and to an arrangement for a rights ticket system for increasing the security of access control to computer resources. According to the invention, in a safe environment, a person that is especially trustworthy produces for a computer a host card with identity information specific of said computer and a personalized set of data in the form of a signed ticket. Said ticket contains information on the rights of a user for at least one RTS computer or on resources of said RTS computer, but also identity information on the host card already produced for the RTS computer. In order to protect the tickets, a common secret information is established that is shared by the host card and the tickets allocated to said host card. After receipt, the user decrypts the signed ticket with the private key of his user card, and then verifies and it stores it in the user card. Access to an RTS computer is enabled only after a mutual authentication via the common secret information between the user card of the user and the host card of the respective computer.

### SPECIFICATION

The present invention relates to a method and an arrangement for a rights ticket system (RTS) which is designed to increase the security of access control to a computer, to a group of computers or to an application. Currently, chip cards are increasingly used for storing personal information. The reason for this is that the chip card technology makes it possible to store this information more securely than on conventional computer systems. In this context, however, critical information about the computer are increasingly also stored on the chip card in addition to user passwords.

For instance, it is known from U.S. Pat. Nos. 5,448,045 and 05,892,902 to externally store parts of the boot program of a computer on the chip card. This solution is designed to prevent the boot program from virus infections. To this end, the chip card (smartcard), after user verification (PIN entry), presents to the computer a previously agreed shared secret so that the computer can load the externally stored information from the smartcard. The shared secret can be signatures for executable programs or cryptographic keys.

A further solution is known from Hamann, Ernst-Michael (1999): Einsatz von frei definierbaren Objekten auf einer Signaturkarte im Internet. [Use of Freely Definable Objects on a Signature Card in the Internet.] In: Horster, Patrick (editor): Sicherheitsinfrastrukturen: Grundlagen, Realisierungen, Rechtliche Aspekte, Anwendungen. [Security Infrastructures: Fundamentals, Implementations, Legal Aspects, Applications.] Vieweg Publishing House, pp. 257-271. In this signature card application, freely definable data objects are stored on a Java card and made available via standard interfaces (RSA PKCS#11 Version 2.01 (Cryptoki); Microsoft Crypto API (CAPI); Common Data Security Architecture (CDSA)). These data objects can be signed together with the card serial number and stored on the chip card. The application which will later use the object can then check via the public key of the creator of the Java card and the card serial number whether the object comes from the respective Java card and was not copied from a different card. This permits storage of a ticket on the signature card. In the case of this solution, the secret shared between the chip card and the computer is stored on the computer itself. In the case that the computer is compromised, however, the shared secret is known to the public. Therefore, the above described method involves security risks.

The method according to the present invention is geared to increasing the security of access control to a computer, a group of computers or to an application. In this context, the intention is for security risks due to unauthorized access or due to access of unauthorized persons to be considerably minimized compared to the known methods.

The basic principle of the solution consists in the generation of a signed electronic ticket by a particularly trustworthy person in a secure environment. The ticket is intended to allow the user controlled access to a computer, to a group of computers, or to an application which is defined within the scope of the ticket. Host cards and user cards are produced in a secure environment, the tickets being stored on the user cards later. Each computer which is included in the rights ticket system (RTS system) and denoted by RTS computer hereinafter, is assigned a host card. On the host card, important secret keys are stored which are required for verification of the user card which is presented to the RTS computer and of the ticket stored on the user card. The host cards are arranged in the RTS computers in such a manner that manipulation from the outside is not possible.

User access to a computer of the RTS system or to an application offered by an RTS computer is enabled only after verification of the host card, of the user card, and of the ticket located on the user card; the ticket of the user card being accessible only via a secret of the host card. In comparison with the known solutions, therefore, the host card constitutes a data storage device which is difficult to manipulate because all important data can either not be changed or can be changed only after PIN verification.

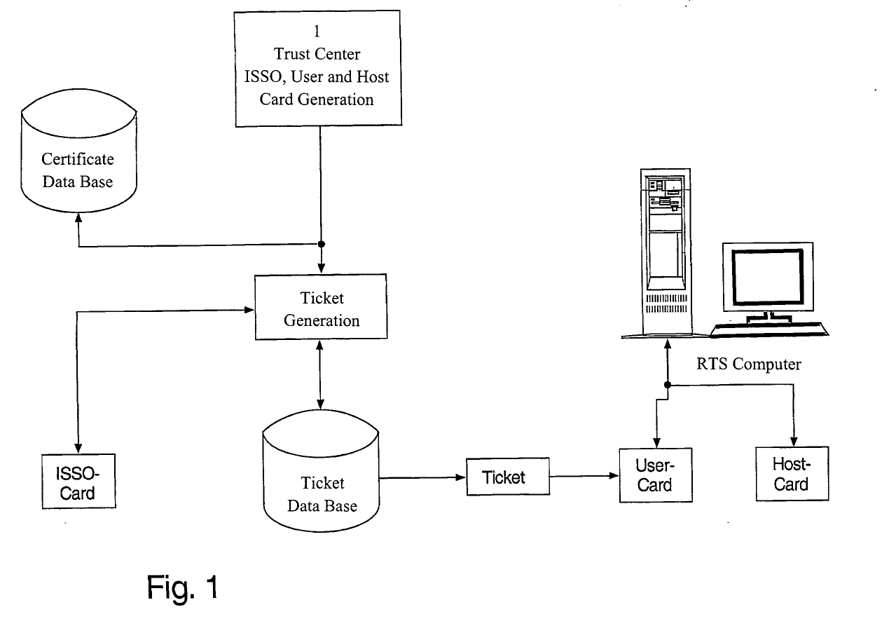

The basic embodiment of the method according to the present invention is shown in FIG. 1 by way of a block diagram. The trust center produces and issues chip cards for the rights tickets system. These chip cards contain the RTS application in addition to other applications (for example, signature function, flextime applications, etc.). Basic information such as records and secret key files are brought onto the chip card in the evaluated trust center. The user card is a chip card which is personalized by the trust center; the host card is only a prepersonalized chip card and is later assigned to an RTS computer.

The technical solution is based on the interplay of a ticket with a computer-bound host card which is described below.

The ticket is created by a particularly trustworthy security administrator ISSO on a secure administration computer RTS Admin using the ISSO chip card. The ISSO chip card is the user card of the security administrator ISSO. All information on the user rights within a specific computer, a group of computers or within an application is stored in the ticket. The personalization of a computer or a group of computers is accomplished by a freely selectable name (alias name). The rights of the user are stored in a ticket and signed together with the public key of the respective user and the alias name of the respective RTS computer, as a result of which the ticket becomes personalized.

Because of this, the ticket is valid only for this user and only for the RTS computer or the RTS computer group having the respective alias name. To sign the ticket, use is made of the private key of the security administrator ISSO who is responsible for the RTS computer. This private key is located on the ISSO chip card. Due to the signature, manipulations to the ticket can be detected by the RTS computer during verification, and the resources of the RTS computer can be prevented from being used. The tickets are created on a particularly secure computer, preferably in a secure environment.

The ticket created by security administrator ISSO is encrypted with the public key of security administrator ISSO and the public key of the user for whom the ticket has been created. Moreover, the ticket can be additionally encrypted with a further card (ISSO backup card). The encrypted ticket is stored in a ticket data base in order for a new ticket to be created on the basis of the existing user data upon loss or destruction of a user card or host card. Moreover, the ticket data base serves as a register of all tickets that have been created.

The ticket which has been created and encrypted for the user is sent to the user electronically (e-mail) or by diskette. Upon receipt of the ticket, the user decrypts the ticket on a secure computer using the private key of his/her user card, verifies the ticket data, and stores this data in his/her user card which he/she has previously received from the trust center by a secure way.

A host card is the prerequisite for generating a ticket. The host card is a prepersonalized chip card which is used on each computer as a highly secure data storage device and which is initialized by the ISSO.

For each ticket which has been created for an RTS computer, there exists an associated ticket key. This ticket key is a shared secret of the host card and the user card which is created during the generation of the host card. The secret is used to protect the tickets stored in the user card from unauthorized reading by foreign computers. To read out from the user card the ticket which is valid for the RTS computer, the RTS computer must prove to the user card that it possesses the same ticket key (stored on the host card).

When logging on to an RTS computer or when accessing a resource on an RTS computer, the user must present to the system a user card on which a valid ticket is stored. To this end, he/she must insert his/her user card into the card reader of the RTS computer, and authenticate himself/herself with his/her personal identification number. The system checks the signature of the ticket using the public key of the security administrator and, upon successful verification, enables access to the system or to the resource.

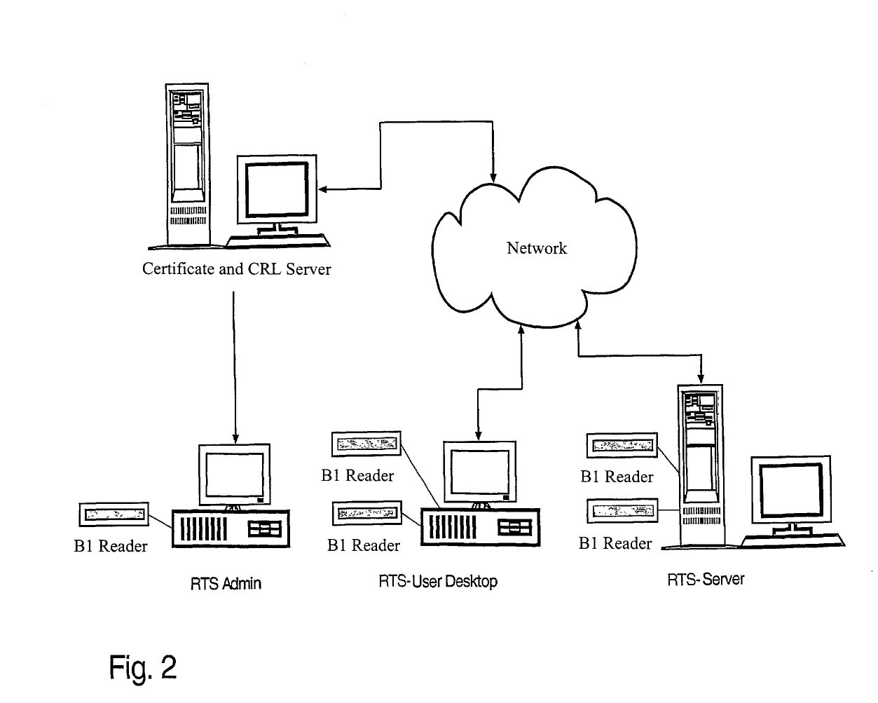

In FIG. 2, the solution according to the present invention is represented by way of an exemplary embodiment for the use of a server over a network. Tickets containing the access rights (in their scope and their time limitation) to the server itself or to applications of the server are created for the server on the RTS Admin computer. On the user desktop, the ticket for the server is then loaded into the chip card of the user. Now, the user can log on to the server with this ticket.

For highest security requirements, the user desktop itself must only be accessed using a ticket. Therefore, the user must already have loaded a ticket for this computer into the user card. The first initialization of a user card for access to a local user desktop is generally carried out by the local security administrator on the RTS Admin computer. Thus, access to a local RTS computer is only possible with a valid ticket.

However, access to an RTS computer is also possible via a local computer which is not provided with a second card reader and consequently does not have a host card either. In the case of this solution, however, one has to accept reductions in the security standard, in contrast to a solution which is exclusively based on RTS computers. However, these reductions are exclusively limited to the local access computer since access to this computer is not protected via a ticket. Access from this local computer to an RTS computer, however, is only possible via a ticket so that here security is fully guaranteed again.

In a possible embodiment, the rights ticket system is used to externally store UNIX user rights to the user card. Thus, these rights, which have hitherto been stored on the hard disk of the computer system, are difficult for a potential attacker to manipulate because they are located in the user card of the user in cryptographically protected form.

In the known solutions heretofore, the user rights stored in a user card are transferred to the computer for verification and then compared to the user rights which are stored on the computer (for example, password of an application). The rights ticket system, however, allows access to the RTS computer only after verification of the ticket using the host card, that is, no comparison takes place between the data contained in the ticket and the data stored on the RTS computer. The user rights are transferred to the RTS computer during the log-on process, and are present on the RTS computer only as long as the user is logged on to the RTS computer. Therefore, it is not possible either to spy out user rights in the absence of the user.

Each RTS computer to which the user can log on locally using his/her ticket is assigned at least two chip card readers. The first chip card reader is used to receive the user card of the user. The second chip card reader is configured to receive the host card.

In the case of a ticket-based log-on from an RTS computer to a remote RTS computer (server), a chip card reader for the user card is arranged on the RTS user computer and a chip card reader for the host card is arranged on the remote RTS computer.

Via the host card, each RTS computer is provided with an identity which can only be changed by physically replacing the host card. As an additional protection mechanism against unauthorized replacement of the host card, the card serial number of the host card is included in the trusted computing base of the RTS computer. The chip card reader configured for the host card is installed in the respective RTS computer in such a manner that the host card can be removed only after opening the computer case. A further additional security measure is to fixedly integrate the host card into the chip card reader for the host card so that the host card can be removed only after opening the chip card reader.

List of reference symbols

| | |
|---|---|
| ISSO: | security administrator (Information System Security Officer) |
| ISSO chip card: | personal chip card of the security administrator |
| User card: | chip card of a user |
| Host card: | chip card for a computer which defines the identity of the |
| | computer in the rights ticket system and contains |
| | information for verifying a ticket which has been |
| | issued for this computer. |
| RTS Admin: | a computer system on which the tickets for different computers are |
| | created by the ISSO |
| RTS computer: | a computer which has been configured for the rights ticket system. |

What is claimed is:

1. A method for a rights ticket system for increasing the security of access control to computer resources, wherein
in a secure environment, a person that is particularly trustworthy
a) creates for an RTS computer a host card with identity information specific of this computer for later verification of at least one ticket;
b) creates a personalized set of data in the form of a signed ticket which contains both information on the rights of a user for at least one RTS computer or on resources of the RTS computer but also identity information on the host card already produced for the RTS computer, a shared secret being established between the host card and the tickets assigned to this host card for protecting the tickets;
the signed ticket, after delivery to the destined user, is decrypted using the private key of the user card of the user, verified and stored in the user card; and
the access of the user to an RTS computer is enabled only after mutual authentication via the shared secret between the user card of the user and the host card of the respective RTS computer or of the respective RTS computers.

2. The method as recited in claim 1,
wherein the shared secret is designed as a symmetrical key and generated in the form of a ticket key during the production of the host card;
after transmission or receipt, the ticket and the ticket key are stored by the destined user in a separate storage device of the user card; and
the ticket can be read by the RTS computer from the user card only after successful verification of the shared ticket key between the ticket of the user and the host card of the respective RTS computer.

3. The method as recited in claim 1,
wherein the user has to additionally identify himself/herself during log-on using the PIN stored on his/her user card.

4. The method as recited in claim 1,
wherein the host card and the tickets assigned to the host card are preferably produced on an administration computer (Admin) in a secure environment by a security administrator (ISSO) who is responsible for the RTS computer, using his/her private key; and
the created tickets are stored in a ticket data base of the administration computer.

5. The method as recited in claim 1,
wherein the ticket which has been created for the user is delivered to him/her electronically.

6. The method as recited in claim 1,
wherein the ticket which has been created by the security administrator is encrypted with the public key of the security administrator and the public key of the intended user, on one hand, to store it in encrypted form in the ticket data base of the administration computer and, on the other hand, to send it to the user in encrypted form.

7. The method as recited in claim 1,
wherein the assignment or identification of an RTS computer or a group of RTS computers to the tickets is accomplished via alias names, a group of RTS computers being assigned an identical alias name.

8. An arrangement for a rights ticket system for increasing the security of access control to computer resources,
wherein each RTS computer which is configured as access computer to allow a user to log on locally using the ticket of his/her user card is assigned at least two chip card readers, the first chip card reader being configured to receive the user card of the user and the second chip card reader being configured to receive the host card.

9. The arrangement as recited in claim 8,
wherein in the case of a log-on from user computer which is not configured as RTS computer to a remote RTS computer (server), only a chip card reader for the user card is arranged on the user computer.

10. The arrangement as recited in claim 8,
wherein the chip card reader configured for the host card is installed in the respective RTS computer in such a manner that the host card can be removed only after opening the computer case.

11. The arrangement as recited in claim 8 and 10,
wherein the host card is fixedly integrated into the chip card reader for the host card so that the host card can be removed only after opening the chip card reader.
